(19) United States
(12) Patent Application Publication
(10) Pub. No.: US 2024/0221338 A1
(43) Pub. Date: Jul. 4, 2024

(54) INFORMATION PROCESSING DEVICE, COMPUTER-READABLE MEDIUM, INFORMATION PROCESSING METHOD, AND INFORMATION PROCESSING SYSTEM

(71) Applicant: Wacom Co., Ltd., Saitama (JP)

(72) Inventor: Nobutaka IDE, Saitama (JP)

(21) Appl. No.: 18/604,320

(22) Filed: Mar. 13, 2024

Related U.S. Application Data
(63) Continuation of application No. PCT/JP2022/039042, filed on Oct. 20, 2022.

(30) Foreign Application Priority Data
Nov. 11, 2021 (JP) 2021-183883

(51) Int. Cl. G06T 19/20; G06T 5/50; G06T 7/70

(52) U.S. Cl. CPC G06T 19/20; G06T 5/50; G06T 7/70; G06T 2207/20221; G06T 2219/2004

(57) ABSTRACT

The present disclosure relates to an information processing device, a computer-readable medium, an information processing method, and an information processing system. An information processing device according to the present disclosure acquires information indicating a current position of a virtual moving object moving aboveground over time, causes artwork to be displayed on a user terminal in a case where the current position of the moving object is included within an imaging range to be captured by the user terminal, and accepts, from the user terminal, a posting of commentary on the artwork displayed by the user terminal.

### BACKGROUND

### Technical Field

The present disclosure relates to an information processing device, a computer-readable medium, an information processing method, and an information processing system for accepting posting of sub-content with respect to main content.

### Description of the Related Art

Generally, artwork created by a given artist has the power to move people, generate some motivation in people, enrich their sensitivity, and the like. For this reason, many people seek opportunities to view artwork.

With regard to a technique for providing users with opportunities to view artwork, there has been a conventionally known system that displays artwork of digital drawing managed on a server on a predetermined display and accepts posts such as comments on the artwork from users. For example, Japanese Patent Laid-Open No. 2020-92408 discloses that users can post comments and the like on artwork to an online community in a system that displays, in a public or private place, artwork managed on a server.

### PRIOR ART DOCUMENT

### Patent Document

Patent Document 1: Japanese Patent Laid-Open No. 2020-92408

### BRIEF SUMMARY

### Technical Problem

In the technique described in Japanese Patent Laid-Open No. 2020-92408, when multiple users access the same server at the same timing, each user views artwork and posts a comment or the like in the same way wherever the users are. As a result, the users cannot obtain a sense of rarity in the opportunities to view the artwork as main content and the opportunities to post comments or the like as sub-content, and it is not possible to provide the users with a special experience through content including the main content and the sub-content.

Therefore, an object of the present disclosure is to provide an information processing device, a computer-readable medium, an information processing method, and an information processing system that can provide users with a special experience through content.

### Technical Solution

An information processing device according to a first aspect of the present disclosure at least one processor and at least one memory storing at least one program that, when executed by the at least one processor, causes the information processing device to: acquire information indicating a current position of a virtual moving object moving aboveground over time, cause artwork to be displayed on a user terminal in a case where the current position of the moving object is included within an imaging range to be captured by the user terminal, and accept, from the user terminal, a posting of commentary on the artwork displayed by the user terminal.

For example, in a case where a user holds a camera of the user terminal up to the sky at a timing when the moving object moves to the user's current position, and the current position of the moving object is included within the imaging range of the camera, then artwork is displayed, and a commentary on the artwork can be posted. Accordingly, in a daily service, an event, or the like for viewing artwork and posting a commentary on the artwork, it is possible to give a production effect as if the artwork had traveled above the earth and visited users. In other words, it is possible to provide users with an experience of “art transcends time and space” and a way of enjoying a new expression of “art visits you.” In this way, it is possible to provide users with a special experience through the content.

An information processing device according to a second aspect of the present disclosure includes at least one processor and at least one memory storing at least one program that, when executed by the at least one processor, causes the information processing device to: set a trajectory indicating a correspondence relation between a position and a time in a three-dimensional space, cause main content corresponding to the trajectory to be displayed on a user terminal in a case where, at least based on a position of the user terminal, part of the trajectory is included within an imaging range to be captured by the user terminal, and accept, from the user terminal, posting of sub-content with respect to the main content displayed by the user terminal.

An information processing device according to a third aspect of the present disclosure, causes an image of a virtual moving object corresponding to the trajectory to be displayed on a user terminal in such that the image of the virtual moving object is superimposed on video captured by the user terminal in a case where the part of the trajectory is included within the imaging range, and causes the main content to be displayed in a case where a predetermined operation with respect to the image of the moving object is accepted from the user terminal.

An information processing device according to a fourth aspect of the present disclosure, when a posting of the sub-content from a user terminal, accepts an input of signature information of a user of the user terminal in association with the sub-content.

An information processing device according to a fifth aspect of the present disclosure, when main content is caused to be displayed, causes the sub-content that has been posted and accepted with respect to the main content to be displayed together with the main content.

An information processing device according to a sixth aspect of the present disclosure, sets a start point and an end point of a trajectory, and outputs sub-content that has been posted and accepted between the start point and the end point, together with main content associated with the sub-content.

A non-transitory computer-readable medium storing a program according to a seventh aspect of the present disclosure causes a computer to set a trajectory indicating a correspondence relation between a position and a time in a three-dimensional space, cause main content corresponding to the trajectory to be displayed on a user terminal in a case where, at least based on a position of the user terminal, part of the trajectory is included within an imaging range to be captured by the user terminal, and accept, from the user terminal, posting of sub-content with respect to the main content displayed by the user terminal.

An information processing method according to an eighth aspect of the present disclosure includes setting a trajectory indicating a correspondence relation between a position and a time in a three-dimensional space, causing main content corresponding to the trajectory to be displayed on a user terminal in a case where, at least based on a position of the user terminal, part of the trajectory is included within an imaging range to be captured by the user terminal, and accepting, from the user terminal, a posting of sub-content with respect to the main content displayed user terminal.

An information processing system according to a ninth aspect of the present disclosure includes a server device and a user terminal which is, in operation, communicates with the server device, in which the server device includes at least one first processor and at least one first memory storing at least one first program that, when executed by the at least one first processor, causes the server device to: set a trajectory indicating a correspondence relation between a position and a time in a three-dimensional space, cause main content corresponding to the trajectory to be displayed on the user terminal in a case where the user terminal determines, at least based on a position of the user terminal, that part of the trajectory is included within an imaging range to be captured by the user terminal, and accept, from the user terminal, a posting of sub-content with respect to the main content displayed by the user terminal, and the user terminal includes at least one second processor and at least one second memory storing at least one second program that, when executed by the at least one second processor, causes the user terminal to: identify the position of the user terminal, determine, based on the position identified by the position identification unit, whether the part of the trajectory is included within the imaging range to be captured by the user terminal, and accept an input of the sub-content.

### Advantageous Effect

According to the present disclosure, users can be provided with a special experience through content.

### BRIEF DESCRIPTION OF THE SEVERAL VIEWS OF THE DRAWINGS

FIG. 1 is a block diagram depicting an example of an overall configuration of an information processing system according to an embodiment of the present disclosure.

FIG. 2 is a block diagram depicting an example of a hardware configuration of a server device depicted in FIG. 1.

FIG. 3 is a block diagram depicting an example of a hardware configuration of a smartphone as a user terminal depicted in FIG. 1.

FIG. 4 is a block diagram depicting an example of functional configurations of the information processing system according to the present embodiment.

FIG. 5 is a conceptual diagram for describing a concept of a trajectory.

FIG. 6 is a diagram depicting an example of a trajectory table.

FIG. 7 is a diagram depicting an example of an artwork table.

FIG. 8 is a diagram depicting an example of a user input image table.

FIG. 9 is a flowchart depicting an example of a flow of processes performed by each functional configuration depicted in FIG. 4 in the information processing system according to the present embodiment.

FIGS. 10A to 10D are diagrams depicting examples of transition diagrams of an application execution screen on the user terminal.

FIGS. 11E to 11H are diagrams depicting examples of the transition diagrams of the application execution screen on the user terminal.

FIGS. 121 and 12L are diagrams depicting examples of the transition diagrams of the application execution screen on the user terminal.

FIG. 13 is a flowchart depicting an example of a flow of processes for outputting a plurality of user input images posted between a start point time and an end point time in the information processing system.

### DETAILED DESCRIPTION

### Overview

An information processing system according to an embodiment of the present disclosure (hereinafter referred to as the “present embodiment”) provides a content sharing application for sharing content including main content and sub-content among users. The main content is, for example, artwork created by a given artist, and the sub-content is, for example, a user input image of a comment or a picture input as a commentary with respect to the artwork from a user terminal. The content sharing application provided by the information processing system according to the present embodiment is an application for giving users an opportunity to view artwork and an opportunity to post user input images, by displaying the artwork.

For example, a user who has activated the content sharing application holds a camera of a user terminal up to the sky at a timing when a comet that is a virtual moving object moves to the current position of the user. In a case where the current position of the comet is included within an imaging range of the camera held up to the sky, the user can be given an opportunity to view the artwork and an opportunity to post a user input image. In this way, the opportunity to view the artwork and the opportunity to post the user input image are limited in terms of location and time, thereby giving a production effect as if the artwork had moved above the earth and visited the user at a once-in-a-lifetime timing.

Further, the content sharing application accepts an input of signature information of the user in association with the posting of the user input image, thereby proving the author of the user input image by the signature information. In other words, this can give an effect of “you can type commentary on art and prove that it is yours.”

The present embodiment is described in detail below with reference to the accompanying drawings. The same constituent elements and processing are denoted with the same symbols in each drawing as much as possible to facilitate understanding of the description, and redundant description is omitted.

### Overall Configuration

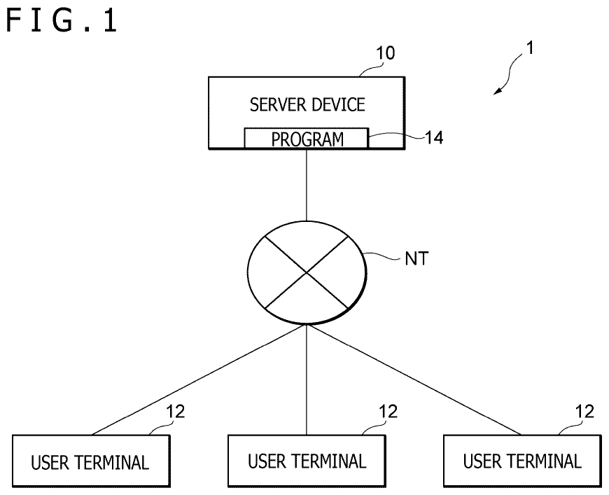

FIG. 1 is a block diagram depicting an example of an overall configuration of an information processing system 1 according to the present embodiment.

As depicted in FIG. 1, the information processing system 1 includes a server device 10 and one or more user terminals 12. The server device 10 and the user terminals 12 are configured to be communicable via a communication network NT such as an intranet, the Internet, or a telephone line.

The server device 10 is an information processing device that provides an execution result obtained by executing a program 14 or the program 14 itself to each of the user terminals 12 via the communication network NT. The server device 10 is realized as, for example, a cloud server.

Each user terminal 12 is an information processing device possessed by each user. Examples of the user terminals 12 include smartphones, mobile phones, tablets, personal computers, and various other devices. In the present embodiment, the user terminals 12 are described as smartphones.

In the present embodiment, a content sharing application is provided from the server device 10 to the users via the user terminals 12. For example, on the basis of a predetermined operation performed by a user on its user terminal 12, the content sharing application as a web application, which is provided via, for example, the communication network NT and used on a web browser, is activated. Examples of the predetermined operation herein include clicking a link on a predetermined website at the user terminal 12 or reading, by the user terminal 12, a QR code (registered trademark) displayed at a content sharing event venue or the like. It is to be noted that, after the program 14 received from the server device 10 is installed in the user terminal 12, the program 14 may be executed on the user terminal 12 to provide the content sharing application to the user.

### Hardware Configuration

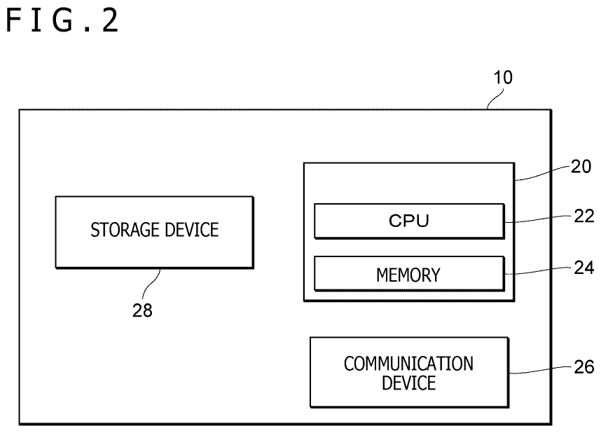

FIG. 2 is a block diagram depicting an example of a hardware configuration of the server device 10 depicted in FIG. 1.

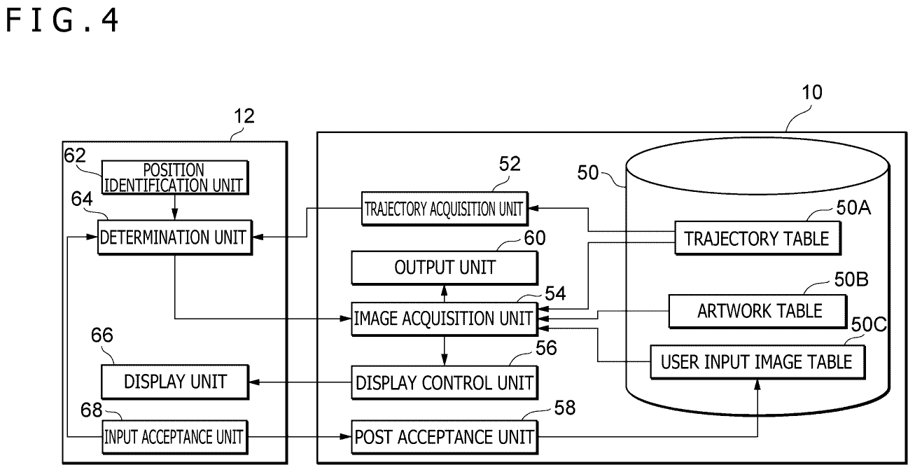

As depicted in FIG. 2, the server device 10 includes a control device 20, a communication device 26, and a storage device 28. The control device 20 mainly includes a processor or central processing unit (CPU) 22 and a memory 24. These constituent elements are operated by a program or the like to function as various functional configurations described below with reference to FIG. 4.

In the control device 20, the CPU 22 executes a predetermined program stored in the memory 24, the storage device 28, or the like.

The communication device 26 includes a communication interface and the like for communicating with external devices. The communication device 26 transmits and receives various kinds of information to and from the user terminals 12, for example.

The storage device 28 includes a hard disk and the like. The storage device 28 stores various programs, including the program 14, and various kinds of information necessary for the execution of processing in the control device 20, and information regarding the result of processing.

It is to be noted that the server device 10 can be realized using an information processing device such as a dedicated or general-purpose server computer. Further, the server device 10 may be constituted by a single information processing device or by a plurality of information processing devices distributed on the communication network NT. Further, FIG. 2 only depicts part of a main hardware configuration of the server device 10, and the server device 10 can have other configurations that servers generally have.

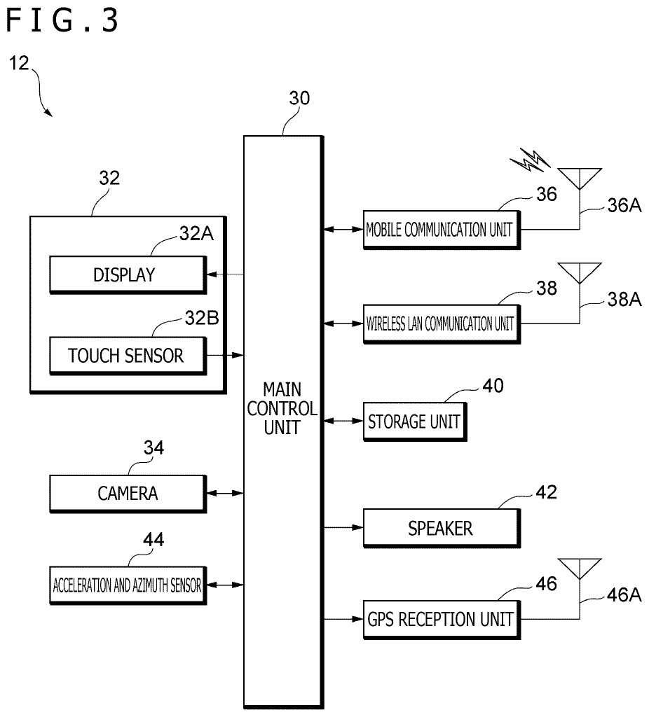

FIG. 3 is a block diagram depicting an example of a hardware configuration of a smartphone as the user terminal 12 depicted in FIG. 1.

As depicted in FIG. 3, the user terminal 12 includes a main control unit 30, a touch panel 32, a camera 34, a mobile communication unit 36, a wireless local area network (LAN) communication unit 38, a storage unit 40, a speaker 42, an acceleration and azimuth sensor 44, and a global positioning system (GPS) reception unit 46. These constituent elements are operated by a program or the like to function as various functional configurations described below with reference to FIG. 4.

The main control unit 30 includes a processor or CPU, a memory, and the like. The touch panel 32, the camera 34, the mobile communication unit 36, the wireless LAN communication unit 38, the storage unit 40, the speaker 42, the acceleration and azimuth sensor 44, and the GPS reception unit 46 are connected to the main control unit 30. In addition, the main control unit 30 has a function of controlling these connection destinations.

The touch panel 32 has functions of both a display device and an input device and includes a display 32A, which serves as a display function, and a touch sensor 32B, which serves as an input function. The display 32A includes, for example, a general display device such as a liquid crystal display or an organic electroluminescence (EL) display. The display 32A displays a screen including an image of the content sharing application generated by, for example, the execution of the program 14.

The touch sensor 32B includes an element for detecting a contact operation on the screen displayed by the display 32A. A contact operation detection method by the touch sensor 32B can employ any method among known methods such as a capacitive method, a resistive film method (pressure-sensitive method), and an electromagnetic induction method. The touch sensor 32B accepts an input of a user operation by detecting a movement of a user's finger, a stylus, or the like as an operator in contact with the screen. When the touch sensor 32B detects the movement of the user's finger, the stylus, or the like, the touch sensor 32B detects coordinates indicating the position of the contact with the screen and outputs the coordinates to the main control unit 30. The coordinates indicating the position are indicated as, for example, coordinate values on an xy plane along the screen displayed by the display 32A.

The camera 34 has functions of capturing a still image and/or a moving image and storing the captured result in the storage unit 40.

The mobile communication unit 36 has functions of connecting to a mobile communication network via an antenna 36A and communicating with other communication devices connected to the mobile communication network.

The wireless LAN communication unit 38 has functions of connecting to the communication network NT via an antenna 38A and communicating with other devices such as the server device 10 connected to the communication network NT.

The storage unit 40 stores various programs including the program 14 and various kinds of information.

The speaker 42 has a function of outputting sound and the like during the execution of the content sharing application.

The acceleration and azimuth sensor 44 has a function of acquiring information for calculating the orientation and tilt of the user terminal 12 and includes various sensors such as an electromagnetic compass for detecting the earth's magnetism, a gyro compass, and an acceleration sensor.

The GPS reception unit 46 has a function of receiving a GPS signal for identifying the position of the user terminal 12 from a GPS satellite via an antenna 46A.

It is to be noted that FIG. 3 depicts only part of a main hardware configuration of the user terminal 12, and the user terminal 12 can have other configurations such as a microphone for receiving an input of sound, a real-time clock, and near-field communication that smartphones generally have.

### Functional Configurations

FIG. 4 is a block diagram depicting an example of functional configurations of the information processing system 1 according to the present embodiment.

### Functional Configurations of Server Device 10

As depicted in FIG. 4, the server device 10 of the information processing system 1 includes, as the functional configurations, a storage unit 50, a trajectory acquisition unit 52, an image acquisition unit 54, a display control unit 56, a post acceptance unit 58, and an output unit 60. It is to be noted that the user terminal 12 may include all or some of these functional configurations.

The storage unit 50 functions as a trajectory setting unit and sets and stores a trajectory indicating a correspondence relation between the position and the time in a three-dimensional space. The position in the three-dimensional space may be a position on the three-dimensional space determined by a three-dimensional position vector or a position determined by a two-dimensional position vector in the three-dimensional space, that is, a position on a two-dimensional plane.

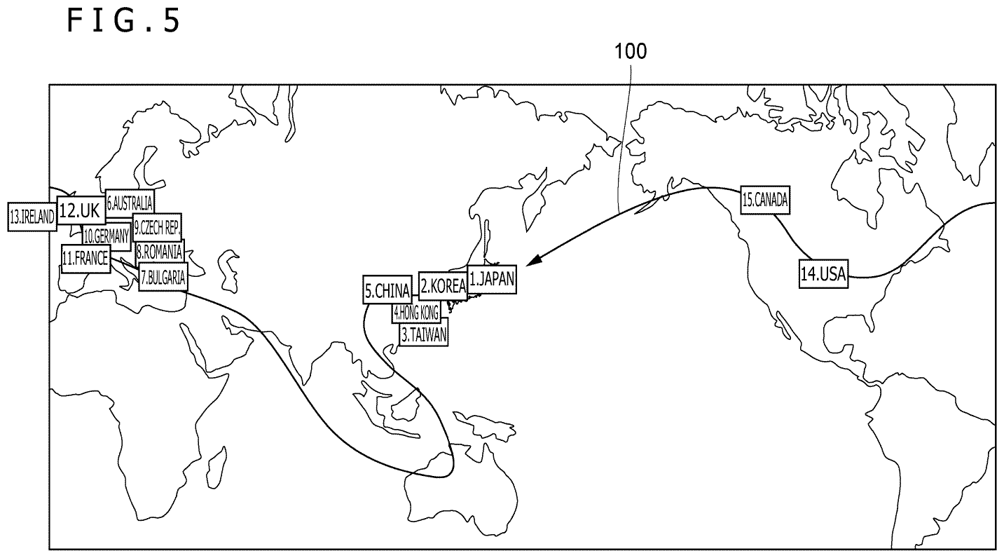

FIG. 5 is a conceptual diagram depicting a concept of a trajectory 100. As depicted in FIG. 5, the trajectory 100 is a path of positions that change with elapse of time, for example, a path that moves over cities around the world, starting and ending in Japan. A start point indicates the position where the trajectory 100 starts, and an end point indicates the position where the trajectory 100 ends. The trajectory 100 is drawn as a path from Japan to South Korea, Taiwan, Hong Kong, China, Australia, Bulgaria, Romania, the Czech Republic, Germany, France, the UK, Ireland, the USA, and Canada, and then back to Japan again, for example.

In addition, the storage unit 50 also sets and stores an image of a comet corresponding to the trajectory 100. The comet herein does not represent a real celestial object but is a virtual moving object that moves above the earth with elapse of time. The comet moves along the trajectory 100 and is set in association with the position of the trajectory 100 and the time.

Returning back to FIG. 4, the storage unit 50 stores a trajectory table 50A, an artwork table 50B, and a user input image table 50C.

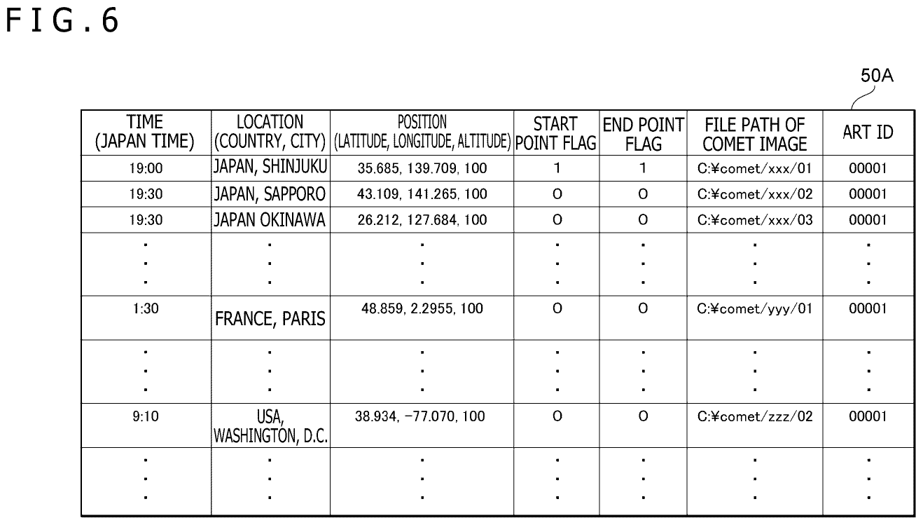

FIG. 6 is a diagram depicting an example of the trajectory table 50A. The trajectory table 50A is a table for setting and managing the trajectory 100. As depicted in FIG. 6, the trajectory table 50A stores positions and times in the three-dimensional space in association with each other. Specifically, the trajectory table 50A stores “time,” “location,” “position,” “start point flag,” “end point flag,” “file path of comet image,” and “art ID” in association with each other.

The “time” is, for example, the 24-hour time indicated in Japan time. The “location” is location information indicating a predetermined region and is indicated by, for example, the name of a country or a city. The “position” is position information on the three-dimensional space and is indicated by, for example, latitude, longitude, and altitude. The altitude may be constant or may be changed according to latitude or longitude. It is to be noted that the “position” may be a position on the two-dimensional plane in the three-dimensional space or may be indicated only by latitude and longitude.

The “start point flag” is a flag indicating whether or not a point associated with a predetermined “time” and a predetermined “position” on the trajectory 100 is a start point. As the “start point flag,” “1” is stored in a case where the point is the start point and “0” is stored in a case where the point is not the start point. The “end point flag” is a flag indicating whether or not a point associated with a predetermined “time” and a predetermined “position” on the trajectory 100 is an end point. As the “end point flag,” “1” is stored in a case where the point is the end point and “0” is stored in a case where the point is not the end point. In the present embodiment, although the start point and the end point are set to the same “time” and “position” in the trajectory table 50A, the “time” at the end point indicates the time 24 hours after the “time” at the start point.

The “file path of comet image” is information indicating a storage location of an image of the comet (hereinafter referred to as a “comet image”) associated with a predetermined “position” and a predetermined “time” on the trajectory 100. It is to be noted that the comet image is set in advance by a designer or the like and is stored in a predetermined storage location in the server device 10. Here, in order to produce different views of the comet depending on which position on the earth the comet is viewed from and at which time, a plurality of comet images which differ from each other for each predetermined “position” and predetermined “time” on the trajectory 100 are stored in the server device 10. For example, a predetermined “position” and a predetermined “time” on the trajectory 100 are associated with a predetermined position and a predetermined time on the earth, and a plurality of comet images are stored on the basis of the correspondence relation.

The “art ID” is identification information of digital drawing artwork (hereinafter simply referred to as “artwork”) created by a given artist. The “art ID” is stored in association with the trajectory 100. In other words, the artwork associated with the trajectory 100 is set.

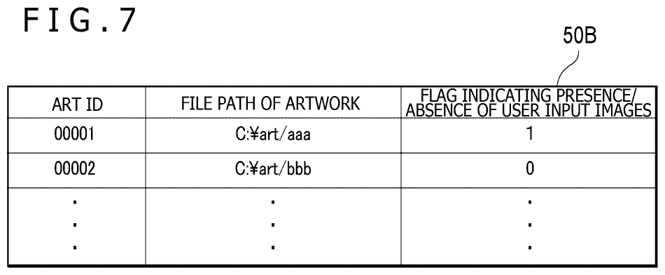

FIG. 7 is a diagram depicting an example of the artwork table 50B. The artwork table 50B is a table for managing artwork in association with the art ID. As depicted in FIG. 7, “art ID,” “file path of artwork,” and “flag indicating presence/absence of user input images” are stored in association with each other in the artwork table 50B.

The “art ID” is identification information of artwork, as with the “art ID” stored in FIG. 6. The “file path of artwork” is information indicating a storage location of artwork. It is to be noted that artwork is set in advance by the designer or the like and is stored in a predetermined storage location in the server device 10.

The “flag indicating presence/absence of user input images” is a flag indicating whether or not there is any user input image associated with the artwork. The user input image is information accepted from the user terminal 12 with respect to the artwork and is an image of a comment, a picture, or the like input by the user, for example. As the “flag indicating presence/absence of user input images,” “1” is stored in a case where there is any user input image associated with the artwork, and “0” is stored in a case where there is no user input image associated with the artwork.

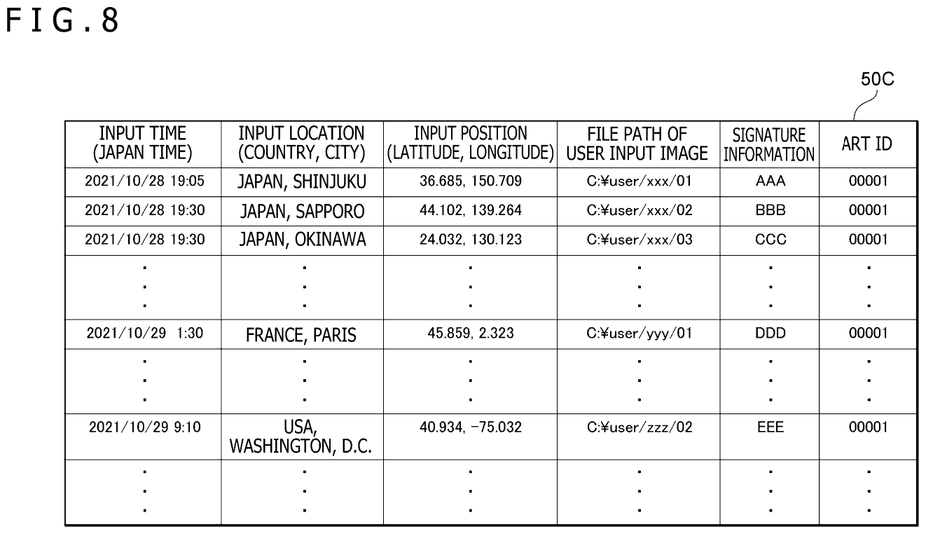

FIG. 8 is a diagram depicting an example of the user input image table 50C. The user input image table 50C is a table for managing user input images in association with the art IDs. As depicted in FIG. 8, “input time,” “input location,” “input position,” “file path of user input image,” “signature information,” and “art ID” are stored in association with each other in the user input image table 50C.

The “input time” is the time at which the posting of the user input image is accepted from the user terminal 12, and is indicated by the 24-hour time in Japan time, for example. The “input time” includes the date indicated as a year, a month, and a date. The “input location” is location information indicating a predetermined region where the posting of the user input image is accepted from the user terminal 12, and is indicated by the name of a country or a city, for example. The “input position” is position information on the two-dimensional plane where the posting of the user input image is accepted from the user terminal 12, and is indicated by latitude and longitude, for example.

The “file path of user input image” is information indicating a storage location of the user input image. It is to be noted that the user input image is stored in a predetermined storage location in the server device 10 when the post is accepted from the user terminal 12. The “signature information” is signature information that has been input from the user terminal 12 in association with the user input image as the signature of the user who has posted the user input image. The “art ID” is identification information of the artwork as with the “art ID” stored in FIGS. 6 and 7.

Returning back to FIG. 4, the trajectory acquisition unit 52 acquires trajectory information from the trajectory table 50A. The trajectory information is information indicating part of the trajectory 100 and indicates, for example, the position corresponding to the current time on the trajectory 100. Here, the comet is set to correspond to the trajectory 100, and the position corresponding to the current time on the trajectory 100 corresponds to the current position of the comet. The position corresponding to the current time on the trajectory 100 is hereinafter described as the current position of the comet. The trajectory acquisition unit 52 functions as a moving object acquisition unit that acquires information indicating the current position of the comet.

For example, in a case where the current time is “19:00,” the trajectory acquisition unit 52 acquires, from the trajectory table 50A, information indicating the current position of the comet corresponding to the current time. In other words, the trajectory acquisition unit 52 acquires the location information “Japan, Shinjuku” corresponding to the same time as the current time and the position information indicating latitude, longitude, and altitude “35.685, 139.709, 100” corresponding to the same time as the current time.

The trajectory acquisition unit 52 acquires information indicating the current position of the comet periodically at predetermined intervals or at a predetermined timing corresponding to a request or the like from the user terminal 12, for example. The trajectory acquisition unit 52 transmits the acquired information indicating the current position of the comet to the user terminal 12. It is to be noted that the current position of the comet corresponding to the current time is not limited to the location information or position information corresponding to exactly the same time as the current time and may also be location information or position information corresponding to a predetermined time period including the current time or a predetermined time period close to the current time.

Further, in a case where the current position of the comet to be acquired is set as the start point or the end point of the trajectory 100, the trajectory acquisition unit 52 acquires flag information indicating it. For example, the trajectory acquisition unit 52 refers to the trajectory table 50A. In a case where the “start point flag” associated with the current position of the comet to be acquired is set to “1,” the trajectory acquisition unit 52 acquires flag information indicating that the current position of the comet is set as the start point. Similarly, in a case where the “end point flag” associated with the current position of the comet to be acquired is set to “1,” the trajectory acquisition unit 52 acquires flag information indicating that the current position of the comet is set as the end point. The trajectory acquisition unit 52 transmits the acquired flag information to the user terminal 12 together with the acquired information indicating the current position of the comet.

In a case where part of the trajectory (the current position of the comet) is included within the imaging range to be captured by the camera 34 of the user terminal 12, the image acquisition unit 54 acquires the comet image corresponding to the current position of the comet. In this case, the image acquisition unit 54 refers to the trajectory table 50A and extracts the “file path of comet image” associated with the current position of the comet included within the imaging range. The image acquisition unit 54 then acquires the comet image stored in the storage location indicated by the extracted “file path of comet image.” The image acquisition unit 54 acquires, for example, the comet image corresponding to the current position of the user terminal 12 from among a plurality of comet images stored in the storage location. In other words, the image acquisition unit 54 acquires the comet image that is appropriate as a view of the comet as viewed from the current position of the user terminal 12, on the basis of the correspondence relation between the current position of the comet and the current position of the user terminal 12. The image acquisition unit 54 outputs the acquired comet image to the display control unit 56.

Further, the image acquisition unit 54 acquires the artwork corresponding to the trajectory 100 in a case where a predetermined operation with respect to the comet image displayed on the display 32A is accepted from the user terminal 12. The predetermined operation is, for example, a zoom operation in which the screen on which the comet image is displayed by the display 32A is zoomed in by user's fingers or the like. It is to be noted that the predetermined operation is not limited to the zoom-in operation and may also be a tap operation or the like.

In this case, the image acquisition unit 54 refers to the trajectory table 50A and identifies the “art ID” associated with the current position of the comet included within the imaging range. Next, the image acquisition unit 54 refers to the artwork table 50B and extracts the “file path of artwork” associated with the identified “art ID.” The image acquisition unit 54 then acquires the artwork stored in the storage location indicated by the extracted “file path of artwork.” The image acquisition unit 54 outputs the acquired artwork to the display control unit 56.

Further, upon acquisition of the artwork, in a case where there is any user input image associated with the artwork to be acquired, the image acquisition unit 54 also acquires the user input image. For example, the image acquisition unit 54 refers to the “flag indicating presence/absence of user input images” column associated with the “art ID” of the artwork to be acquired in the artwork table 50B. In a case where the “flag indicating presence/absence of user input images” is “1,” the image acquisition unit 54 refers to the user input image table 50C and acquires the corresponding user input image. In this case, the image acquisition unit 54 extracts the “file path of user input image” associated with the “art ID” of the artwork to be acquired and acquires the user input image stored in the storage location indicated by the “file path of user input image.” The image acquisition unit 54 outputs the acquired user input image to the display control unit 56 together with the artwork corresponding to the user input image.

Further, the image acquisition unit 54 acquires a plurality of user input images that have been posted and accepted between the start point and the end point of the trajectory 100. For example, the image acquisition unit 54 determines whether or not the current time has elapsed from the time set as the start point of the trajectory 100 (hereinafter referred to as the “start point time”) to the time set as the end point of the trajectory 100 (hereinafter referred to as the “end point time”). In a case where the determination is positive, the image acquisition unit 54 acquires a plurality of user input images posted between the start point time and the end point time.

In this case, the image acquisition unit 54 refers to the user input image table 50C and extracts all user input images included between the start point time and the end point time from the “file paths of user input images” associated with the artwork corresponding to the trajectory 100. It is to be noted that, instead of extracting all the user input images between the start point time and the end point time, the image acquisition unit 54 may further select and extract a plurality of user input images from among them. The image acquisition unit 54 then acquires the user input image stored in the storage location indicated by each of the extracted “file paths of user input images.” The image acquisition unit 54 outputs the acquired plurality of user input images to the output unit 60, together with the artwork corresponding to the user input images.

It is to be noted that, in a case where, for example, the start point (the current position of the comet set as the start point) of the trajectory 100 is included within the imaging range of the user terminal 12 and then the end point (the current position of the comet set as the end point) of the trajectory 100 is included again within the imaging range of the same user terminal 12, the image acquisition unit 54 may acquire a plurality of user input images posted between the start point time and the end point time.

The display control unit 56 controls the screen display of the display 32A of the user terminal 12 that is executing the content sharing application. For example, the display control unit 56 causes the screen including each image acquired by the image acquisition unit 54 to be displayed on the display 32A of the user terminal 12. In a case where part of the trajectory 100 (the current position of the comet) is included within the imaging range to be captured by the camera 34 of the user terminal 12, at least on the basis of the position of the user terminal 12, the display control unit 56 causes the artwork corresponding to the trajectory 100 to be displayed. The position of the user terminal 12 is, for example, the current position of the user terminal 12. The imaging range is calculated on the basis of a pre-set angle of view of the camera 34, the distance from the camera 34 to a subject, and so forth. The imaging range includes a horizontal imaging range and a vertical imaging range.

In the present embodiment, in a case where the current position of the comet is included within the imaging range on the basis of the orientation, tilt, and the like of the user terminal 12 in addition to the current position of the user terminal 12, the display control unit 56 causes the artwork corresponding to the trajectory 100 to be displayed. The orientation of the user terminal 12 is an orientation of the user terminal 12 in the horizontal direction and indicates, for example, a direction in which a lens of the camera 34 of the user terminal 12 faces. Further, the tilt of the user terminal 12 is an angle of the user terminal 12 in a direction intersecting the horizontal direction and indicates how much the user terminal 12 is tilted with respect to the horizontal direction.

It is to be noted that the determination of whether or not the current position of the comet is included within the imaging range includes not only whether or not the current position of the comet is actually within the imaging range, but also a case where the current position of the comet is estimated to be within the imaging range. This estimation may be performed only using the current position of the user terminal 12. For example, in a case where the current position of the user terminal 12 is close to the current position of the comet in terms of the two-dimensional plane, for example, in a case where the current position of the user terminal 12 is located within a predetermined range from the current position of the comet, the current position of the comet may be estimated to be included within the imaging range. Further, this estimation may be performed using at least one of the azimuth (orientation), the elevation angle (tilt), and the altitude in addition to the current position of the user terminal 12 or may be performed using a result of recognition of a captured image instead of the elevation angle and the altitude. Specifically, in the case of using the result of the recognition of a captured image, the current position of the comet may be estimated to be included within the imaging range in a case where the area of a sky region in the captured image where a color value is flat and the region is recognized as the sky occupies a predetermined value or more in relation to the area of the entire captured image.

In the present embodiment, in a case where the current position of the comet is included within the imaging range, the display control unit 56 first causes the comet image to be displayed and then causes the artwork to be displayed in response to acceptance of a zoom-in operation or the like with respect to the comet image from the user. Further, in a case where there is any user input image posted and accepted with respect to the artwork to be displayed, the display control unit 56 causes the user input image to be displayed together with the artwork.

Further, when the display control unit 56 causes the comet image, the artwork, or the user input image to be displayed, the display control unit 56 causes these images to be displayed in such a manner as to be superimposed on a video captured by the camera 34 of the user terminal 12. In other words, the display control unit 56 causes these images to be displayed in such a manner as to be superimposed on a video actually captured by the camera 34, by using what is generally called an augmented reality (AR) method.

The post acceptance unit 58 accepts, from the user terminal 12, the posting of the user input image with respect to the artwork displayed by the display control unit 56. At this time, the post acceptance unit 58 accepts the input of the signature information of the user of the user terminal 12 in association with the user input image. The post acceptance unit 58 stores the accepted user input image in a predetermined storage location in the server device 10. Further, the post acceptance unit 58 also stores the storage location as the “file path of user input image” in the user input image table 50C in association with the “art ID” together with the accepted signature information. Further, the post acceptance unit 58 also stores the time, location, and position at which the user input image was accepted, in the user input image table 50C as the “input time,” the “input location,” and the “input position,” respectively, in association with the “file path of user input image.”

The output unit 60 outputs, together with the artwork, a plurality of user input images that have been posted and accepted between the start point and the end point of the trajectory 100. Specifically, in a case where the current time has elapsed from the start point time to the end point time, the output unit 60 outputs, together with the artwork, the plurality of user input images acquired by the image acquisition unit 54. Further, the output unit 60 may output the plurality of user input images at a timing when the start point (the current position of the comet set as the start point) of the trajectory 100 is included within the imaging range of the user terminal 12 and then the end point (the current position of the comet set as the end point) of the trajectory 100 is included again within the imaging range of the same user terminal 12.

The output unit 60 outputs the plurality of user input images and the artwork by, for example, having them projected as projection mapping onto a ceiling or the like at a content sharing event venue. It is to be noted that the output unit 60 may output the plurality of user input images and the artwork by causing them to be displayed on the display 32A of the user terminal 12 or may output them to a storage device or the like within or outside the server device 10.

### Functional Configurations of User Terminal 12

Next, the user terminal 12 in the information processing system 1 includes, as functional configurations, a position identification unit 62, a determination unit 64, a display unit 66, and an input acceptance unit 68. It is to be noted that the server device 10 may include all or some of these functional configurations.

The position identification unit 62 identifies position information including the current position, orientation, and tilt of the user terminal 12. The position identification unit 62 identifies the current position of the user terminal 12 on the basis of, for example, a position measurement technique based on a GPS signal received by the GPS reception unit 46, an IP address of the user terminal 12, or the like. Further, the position identification unit 62 detects and identifies the orientation and tilt of the user terminal 12 on the basis of various kinds of information acquired by, for example, the acceleration and azimuth sensor 44. The position identification unit 62 periodically identifies position information at, for example, predetermined intervals and outputs the identified position information to the determination unit 64.

On the basis of the position information identified by the position identification unit 62, the determination unit 64 determines whether or not the current position of the comet indicated by the trajectory information acquired by the trajectory acquisition unit 52 is included within the imaging range of the camera 34. In a case where that the determination is positive, the determination unit 64 transmits the determination result to the image acquisition unit 54 of the server device 10.

For example, the determination unit 64 determines whether or not the current position of the comet is included within both the horizontal imaging range and the vertical imaging range, on the basis of the current position, orientation, and tilt of the user terminal 12. Further, in a case where the determination is positive, the determination unit 64 makes a positive determination that the current position of the comet is included within the imaging range. In a case where the determination is negative, the determination unit 64 makes a negative determination that the current position of the comet is not included within the imaging range. It is to be noted that the determination unit 64 may only determine whether or not the current position of the comet is included within the horizontal imaging range, without taking into account the vertical imaging range.

Further, after the start point (the current position of the comet set as the start point) of the trajectory 100 is included within the imaging range of the user terminal 12, the determination unit 64 may determine whether or not the end point (the current position of the comet set as the end point) of the trajectory 100 is included within the imaging range of the user terminal 12. Whether or not the current position of the comet is set as the start point or the end point is determined on the basis of the flag information transmitted from the trajectory acquisition unit 52. The determination unit 64 transmits a result of the determination to the image acquisition unit 54 and the output unit 60 of the server device 10.

Further, the determination unit 64 determines whether or not a predetermined input operation has been accepted from the user terminal 12, on the basis of information from the input acceptance unit 68. For example, in a case where zoom-in operation information is output from the input acceptance unit 68, the determination unit 64 determines that a zoom-in operation with respect to the comet image displayed on the display 32A has been performed. The determination unit 64 transmits a result of the determination to the image acquisition unit 54. Further, in a case where the input operation information with respect to the artwork is output from the input acceptance unit 68, the determination unit 64 determines that the user's input operation with respect to the artwork has been performed.

The display unit 66 is the display 32A, which displays an image under the control of the display control unit 56 of the server device 10. For example, in a case where the current position of the comet is included within the imaging range to be captured by the camera 34, the display unit 66 displays the comet image acquired by the image acquisition unit 54 of the server device 10, in such a manner that the comet image is superimposed on a video captured by the camera 34. Further, the display unit 66 displays the artwork acquired by the image acquisition unit 54 and the user input image associated with the artwork, in response to the user's zoom-in operation performed with respect to the screen including the comet image.

The input acceptance unit 68 is the touch sensor 32B, which accepts the input of the predetermined operation from the user. For example, assume that, in a case where the display 32A is displaying the screen including the comet image, a zoom-in operation is performed with respect to the screen by user's fingers. In this case, the input acceptance unit 68 detects and accepts the zoom-in operation with use of the touch sensor 32B and outputs the zoom-in operation information indicating that the zoom-in operation has been performed to the determination unit 64.

Further, for example, assume that, in a case where the display 32A is displaying the screen including the artwork, the user input image such as a comment or a picture on the artwork or the signature information such as the user's signature is input to the screen by the user's finger, the stylus, or the like. In this case, the input acceptance unit 68 detects and accepts the input operation from the user's finger, stylus, or the like with use of the touch sensor 32B and outputs to the determination unit 64 input operation information indicating that the input operation has been performed. Further, the input acceptance unit 68 transmits the accepted user input image and signature information to the post acceptance unit 58 in association with each other.

### Flow of Processes of Information Processing System 1

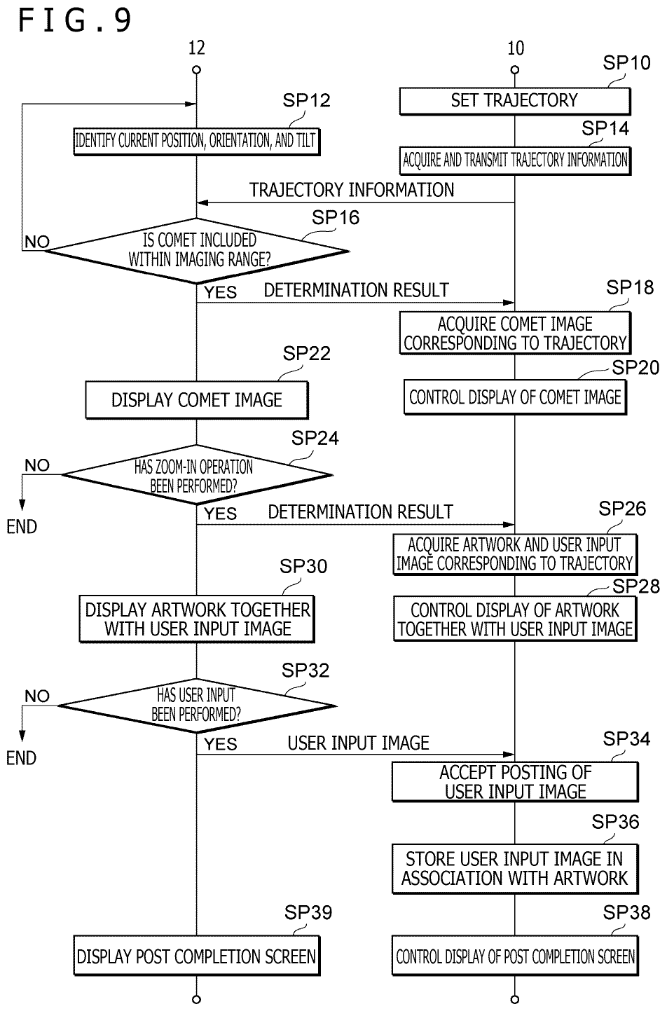

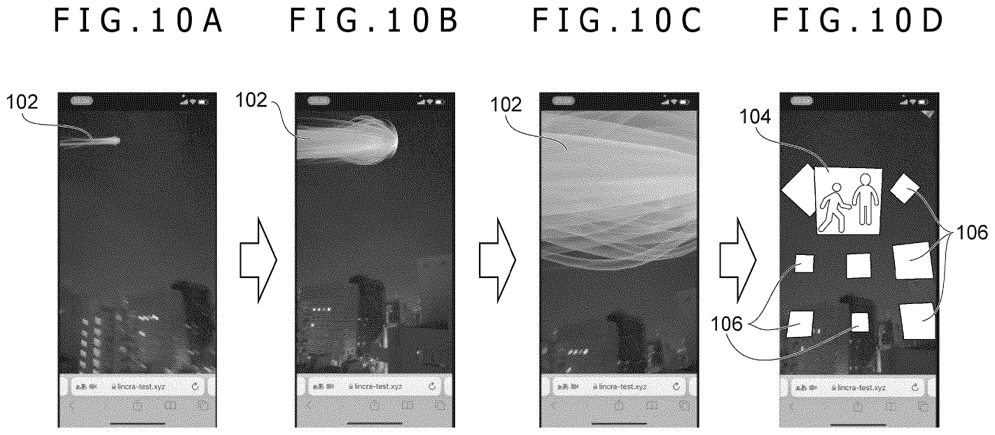

Next, a flow of processes by each functional configuration of the information processing system 1 is described with reference to a flowchart of FIG. 9 and screen transition diagrams of FIGS. 10A to 10D. FIG. 9 is a flowchart depicting an example of a flow of processes performed by each functional configuration depicted in FIG. 4 in the information processing system according to the present embodiment. It is to be noted that the order of the following processing can be changed as appropriate.

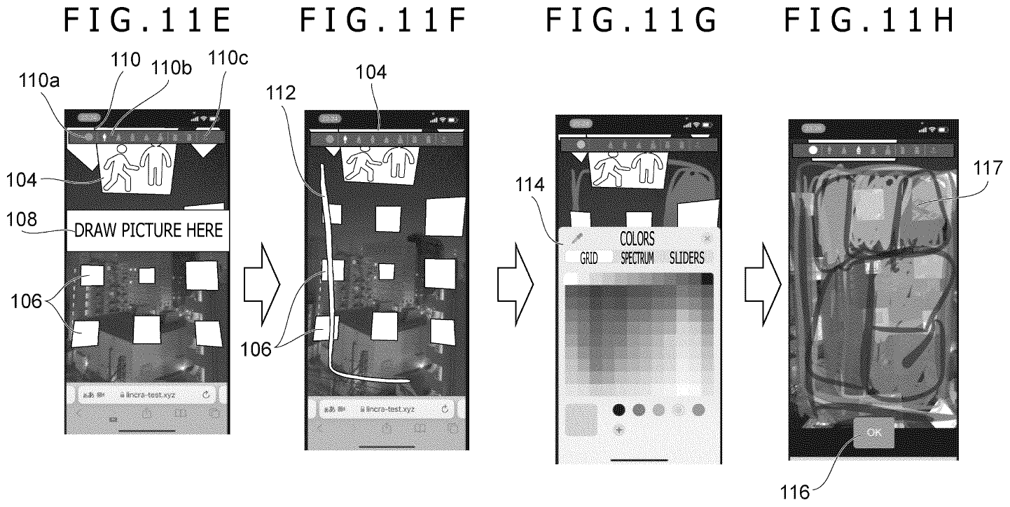

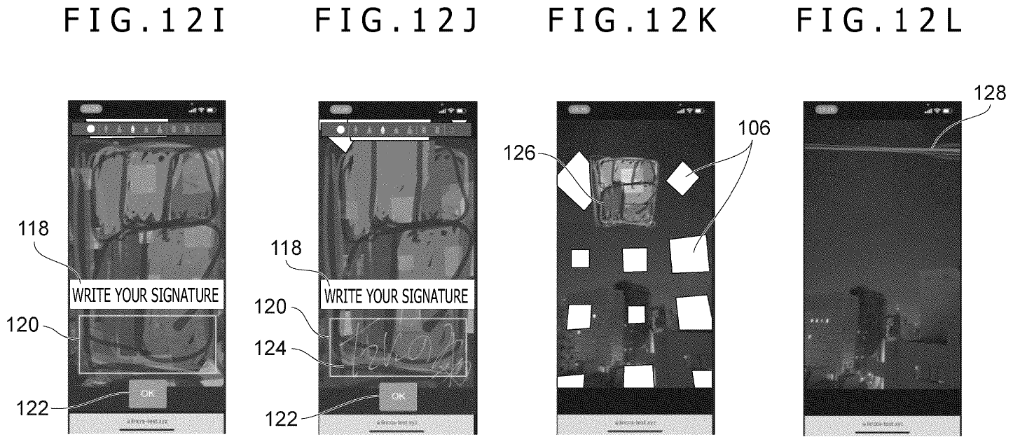

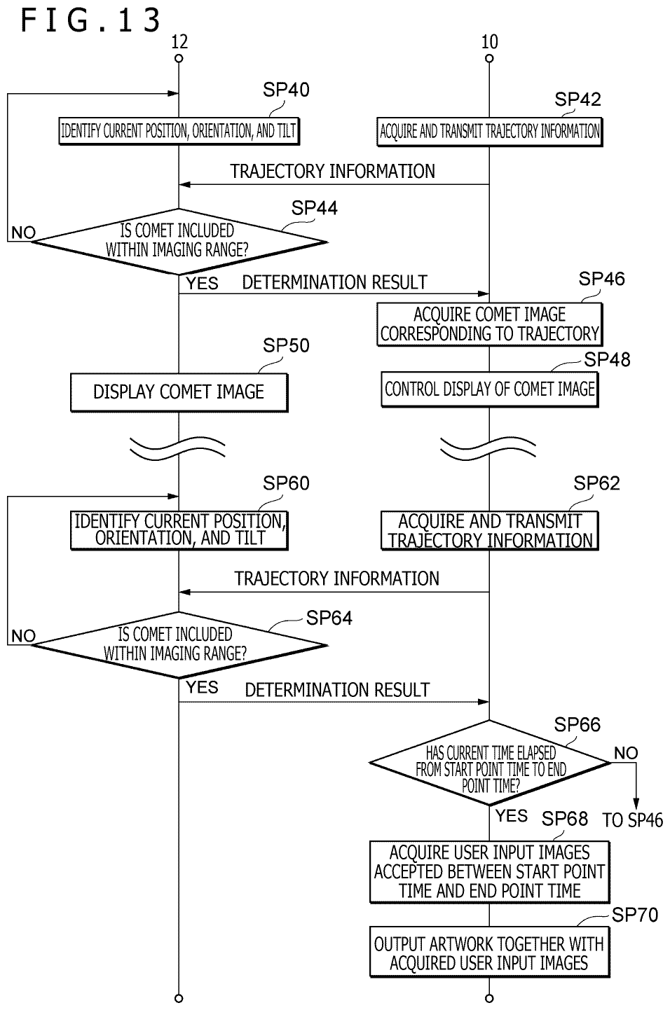

Further, FIGS. 10A to 12L are diagrams depicting examples of transition diagrams of an execution screen of the content sharing application on the user terminal 12. FIGS. 10A to 10D depict a screen flow from when the comet image is displayed to when the artwork is displayed. FIGS. 11E to 11H depict a screen flow from when the artwork is displayed to when the input of the user input image is accepted. FIGS. 12I and 12L depict a screen flow until the posting of the user input image is accepted together with the input of the signature after the user input image is input.

### (SP10)

The storage unit 50 of the server device 10 sets the trajectory 100 and stores the trajectory 100 as the trajectory table 50A.

For example, when the user clicks on a link on a predetermined website on the user terminal 12 or when the user causes the user terminal 12 to read a QR code (registered trademark) displayed at an event venue or the like, the content sharing application is activated on a web browser of the user terminal 12, and processing of SP12 starts.

### (SP12)

The position identification unit 62 of the user terminal 12 identifies position information including the current position, orientation, and tilt of the user terminal 12. The processing then proceeds to processing of SP14.

### (SP14)

In response to, for example, the identification of the position information in the processing of SP12 or at a predetermined timing, the trajectory acquisition unit 52 of the server device 10 acquires, as trajectory information, information indicating the current position of the comet and transmits the trajectory information to the determination unit 64 of the user terminal 12. The processing then proceeds to processing of SP16.

### (SP16)

The determination unit 64 of the user terminal 12 determines, on the basis of the position information identified in the process at SP12, whether or not the current position of the comet indicated by the trajectory information transmitted in the process of SP14 is included within the imaging range of the camera 34. When the determination is negative, the processing proceeds to the process of SP12. In other words, the processing from SP12 to SP16 are repeated until the current position of the comet is included within the imaging range. On the other hand, when the determination is positive, the determination unit 64 transmits the determination result to the image acquisition unit 54 of the server device 10. The processing then proceeds to processing of SP18.

### (SP18)

The image acquisition unit 54 of the server device 10 acquires the comet image corresponding to the trajectory 100. For example, the image acquisition unit 54 extracts, from the trajectory table 50A, the “file path of comet image” associated with the current position of the comet determined to be within the imaging range in the processing of SP16. Subsequently, the image acquisition unit 54 acquires the comet image that is appropriate as a view of the comet viewed from the current position of the user terminal 12, from among comet images stored in the storage location indicated by the “file path of comet image.” The processing then proceeds to processing of SP20.

### (SP20)

The display control unit 56 of the server device 10 causes the comet image acquired in the processing of SP18 to be displayed on the display 32A of the user terminal 12. At this time, the display control unit 56 causes the comet image to be displayed in such a manner as to be superimposed on a video captured by the camera of the user terminal 12. The processing then proceeds to processing of SP22.

### (SP22)

The display 32A, which is the display unit 66 of the user terminal 12, displays the comet image under the control by the display control unit 56 in the processing of SP20. The display 32A displays a comet image 102 in such a manner that the comet image 102 is superimposed on a video of the sky above the city captured by the camera 34 as depicted in FIG. 10A, for example. The processing then proceeds to processing of SP24.

### (SP24)

The determination unit 64 of the user terminal 12 determines, for example, whether or not a zoom-in operation has been accepted from the user within a predetermined period of time after the comet image 102 is displayed in the processing of SP22. In a case where the predetermined period of time has elapsed without the output of the zoom-in operation information from the input acceptance unit 68, the determination unit 64 makes a negative determination. When the determination is negative, the content sharing application ends, and a series of processes depicted in FIG. 9 ends.

On the other hand, in a case where the zoom-in operation information has been output from the input acceptance unit 68, the determination unit 64 makes a positive determination. When the determination is positive, the display 32A performs a zoom-in display. The display 32A displays the comet image 102 enlarged at a certain magnification as depicted in FIGS. 10B and 10C, for example. The determination unit 64 transmits the determination result as positive determination to the image acquisition unit 54 of the server device 10. The processing then proceeds to processing of SP26.

### (SP26)

The image acquisition unit 54 of the server device 10 acquires the artwork and user input image corresponding to the trajectory 100 according to the determination result as positive determination in the process of SP24. For example, the image acquisition unit 54 refers to the trajectory table 50A and identifies the “art ID” associated with the current position of the comet that is determined to be included within the imaging range in the processing of SP16. Subsequently, the image acquisition unit 54 refers to the artwork table 50B, extracts the “file path of artwork” associated with the identified “art ID,” and acquires the artwork stored in the storage location indicated by the “file path of artwork.”

Further, the image acquisition unit 54 refers to the artwork table 50B, and in a case where the “flag indicating presence/absence of user input images” associated with the “art ID” of the artwork to be acquired is “1,” the image acquisition unit 54 acquires the corresponding user input image by referring to the user input image table 50C. In other words, the image acquisition unit 54 extracts the “file path of user input image” associated with the “art ID” of the artwork to be acquired and acquires the user input image stored in the storage location indicated by this “file path of user input image.” The processing then proceeds to processing of SP28.

### (SP28)

The display control unit 56 of the server device 10 causes the artwork and user input image acquired in the processing of SP26 to be displayed on the display 32A of the user terminal 12. At this time, the display control unit 56 causes the artwork and the user input image to be displayed in such a manner as to be superimposed on the video captured by the camera of the user terminal 12. In a case where no user input image has been acquired, the display control unit 56 may cause only the artwork to be displayed. The processing then proceeds to processing of SP30.

### (SP30)

The display 32A, which is the display unit 66 of the user terminal 12, displays the artwork and the user input image under the control by the display control unit 56 in the processing of SP28. For example, the display 32A displays artwork 104 and user input images 106 superimposed on a video of the sky above the city captured by the camera 34, as depicted in FIG. 10D. The display 32A may display the artwork 104 at such a position close to the center that the artwork 104 is most prominent, and may display the user input images 106 in such a manner that the user input images 106 surround the artwork 104.

Further, after performing the display as depicted in FIG. 10D for a predetermined period of time, the display 32A also displays a post prompt icon 108 to encourage the user to post a comment, a picture, or the like with respect to the artwork 104, as depicted in FIG. 11E, for example. Further, in response to the display of the post prompt icon 108, when an input by a user's finger, a stylus, or the like is accepted by the input acceptance unit 68, the display 32A displays a drawn line 112 drawn by the finger, the stylus, or the like, as depicted in FIG. 11F. This drawn line 112 forms a picture 117 as depicted in FIG. 11H.

Further, the display 32A displays a toolbar 110 including a color selection button 110a, a pen selection button 110b, and an OK button 110c. The color selection button 110a is an icon for selecting the color of the drawn line 112. When the color selection button 110a is selected by the user, the display 32A displays a color palette 114 as depicted in FIG. 11G. Further, the pen selection button 110b is an icon for selecting the type of the thickness or the like of the drawn line 112. Further, the OK button 110c is an icon for temporarily storing a comment, a picture, or the like that has been input. When the display 32A displays the post prompt icon 108, the processing proceeds to processing of SP32.

### (SP32)

The determination unit 64 of the user terminal 12 determines whether or not a user's input operation with respect to the artwork 104 has been performed within a predetermined period of time after the post prompt icon 108 is displayed in the process of SP30, for example. In a case where the predetermined period of time has elapsed without the output of input operation information from the input acceptance unit 68, the determination unit 64 makes a negative determination. When the determination is negative, the content sharing application ends, and the series of processing depicted in FIG. 9 ends. On the other hand, in a case where the input operation information has been output from the input acceptance unit 68, the determination unit 64 makes a positive determination.

When the input acceptance unit 68 accepts the input operation information, for example, when the picture 117 as depicted in FIG. 11H is formed as the result of the drawing by the user with the finger or the stylus and the user selects an OK button 116, the input acceptance unit 68 temporarily stores image data of the picture 117 as the user input image 106. Subsequently, the display 32A displays a signature prompt icon 118 “write your signature,” which prompts the user to input a signature, a signature column 120, and an OK button 122, as depicted in FIG. 12I, for example.

Subsequently, when the input of the signature by the user's finger, the stylus, or the like is accepted by the input acceptance unit 68 in response to the display of the signature prompt icon 118, the display 32A displays a signature line 124 drawn with the finger, the stylus, or the like, as depicted in FIG. 12J. Subsequently, when the user selects the OK button 122, the input acceptance unit 68 accepts the input signature line 124 as the signature information and the previously stored picture 117 as the user input image 106, and transmits them to the server device 10 in association with each other. The processing then proceeds to processing of SP34.

### (SP34)

The post acceptance unit 58 of the server device 10 receives and accepts the user input image 106 and signature information transmitted from the input acceptance unit 68 of the user terminal 12 in the process of SP32. The processing then proceeds to processing of SP36.

### (SP36)

The post acceptance unit 58 stores the user input image 106 accepted in the process of SP34 in a predetermined storage location in the server device 10. At this time, the post acceptance unit 58 stores the “file path of user input image,” which is the storage location of the user input image 106, in the user input image table 50C together with the “signature information” such that the “file path of user input image” and the “signature information” are associated with the “art ID.” Further, the post acceptance unit 58 stores the time, location, and position at which the user input image 106 was accepted in the user input image table 50C in association with the “file path of user input image.” The processing then proceeds to processing of SP38.

### (SP38)

The display control unit 56 of the server device 10 causes a post completion screen, which indicates that the posting of the user input image 106 has been completed, to be displayed on the display 32A of the user terminal 12. The processing then proceeds to processing of SP39.

### (SP39)

The display 32A of the user terminal 12 displays the post completion screen under the control by the display control unit 56 in the process of SP38. For example, as depicted in FIG. 12K, the display 32A displays a post icon image 126, which is obtained by zooming-out the user input image 106 which has been posted and accepted in the process of SP34, together with the other user input images 106. Subsequently, the display 32A displays an animation 128, which depicts the trajectory of the fired comet. It is to be noted that the animation is, for example, set in advance in the server device 10. Accordingly, production can be given as if the user input images 106 had been launched into the sky on the video captured by the camera 34 of the user terminal 12 and then fired as the comet.

The series of processing depicted in FIG. 9 ends as above. It is to be noted that the processing may end in the middle of the series of processing depicted in FIG. 9 at a predetermined timing, for example, at a timing when the user's selection of a button or the like for terminating the content sharing application is accepted from the user terminal 12.

Next, a flow of processing for outputting a plurality of user input images posted between the start point time and the end point time in the information processing system 1 is described with reference to a flowchart in FIG. 13.

FIG. 13 is a flowchart depicting an example of the flow of processes for outputting a plurality of user input images 106 posted between the start point time and the end point time in the information processing system 1. When the user performs a predetermined operation on the user terminal 12 to activate the content sharing application, the following processing starts. It is to be noted that the order of the following processing can be changed as appropriate.

### (SP40)

The position identification unit 62 of the user terminal 12 identifies position information including the current position, orientation, and tilt of the user terminal 12. The processing then proceeds to processing of SP42.

### (SP42)

In response to, for example, the identification of the position information at SP40 or at a predetermined timing, the trajectory acquisition unit 52 of the server device 10 acquires, as trajectory information, information indicating the current position of the comet and transmits the trajectory information to the determination unit 64 of the user terminal 12. At this time, in a case where the acquired current position of the comet is set as the start point, the trajectory acquisition unit 52 acquires flag information indicating it and transmits the flag information to the determination unit 64 of the user terminal 12 together with the trajectory information. The processing then proceeds to processing of SP44.

### (SP44)

The determination unit 64 of the user terminal 12 determines, on the basis of the position information identified in the process of SP40, whether or not the current position of the comet indicated by the trajectory information transmitted at SP42 is included within the imaging range of the camera 34. When the determination is negative, the processing proceeds to the processing of SP40. In other words, the processing of SP40 to SP44 are repeated until the current position of the comet is included within the imaging range. On the other hand, when the determination is positive, the determination unit 64 transmits the determination result to the image acquisition unit 54 of the server device 10. Further, at this time, in a case where the current position of the comet transmitted in the process of SP42 is set as the start point, the determination unit 64 stores the fact that the start point is included within the imaging range. The processing then proceeds to processing of SP46.

Since the processing of SP46 to SP50 is similar to the processing of SP18 to SP22 of FIG. 9, the description thereof is omitted. Further, following the processing of SP50, processes similar to the processing of SP24 to SP39 of FIG. 9 is performed, and the posting of the user input image 106 is accepted. In this way, a series of processing until the user input image 106 is accepted can be performed by a plurality of different user terminals 12 that are at locations each corresponding to the current position of the comet that is moving. For example, assume that the artwork 104 is displayed at the user terminal 12 at a timing at 19:00 in Shinjuku, Japan, and the posting of the user input image 106 is accepted. After that, at a timing several hours later than 19:00 at a different location from Shinjuku, Japan (e.g., at 1:00 in Paris, France), the artwork 104 is displayed on the user terminal 12 of another user together with the user input image 106 that has already been posted and accepted, and the posting of another user input image 106 is accepted.

After the user of the user terminal 12 posts the user input image 106, the user terminates the content sharing application once. Then, after a predetermined period of time (e.g., 24 hours) has elapsed since the user input image 106 was posted, for example, the user performs a predetermined operation on the user terminal 12 to activate the content sharing application again. This starts processing of SP 60.

### (SP60)

The position identification unit 62 of the user terminal 12 identifies position information including the current position, orientation, and tilt of the user terminal 12. The processing then proceeds to processing of SP62.

### (SP62)

In response to, for example, the identification of the position information in the processing of SP60 or at a predetermined timing, the trajectory acquisition unit 52 of the server device 10 acquires, as trajectory information, information indicating the current position of the comet and transmits the trajectory information to the determination unit 64 of the user terminal 12. At this time, in a case where the acquired current position of the comet is set as the end point, the trajectory acquisition unit 52 acquires flag information indicating it and transmits the flag information to the determination unit 64 of the user terminal 12 together with the trajectory information. The processing then proceeds to processing of SP64.

### (SP64)

The determination unit 64 of the user terminal 12 determines, on the basis of the position information identified at SP60, whether or not the current position of the comet indicated by the trajectory information transmitted at SP62 is included within the imaging range of the camera 34. When the determination is negative, the processing proceeds to the processing of SP60. In other words, the processing of SP60 to SP64 are repeated until the current position of the comet is included within the imaging range. On the other hand, when the determination is positive, the determination unit 64 transmits the determination result to the image acquisition unit 54 of the server device 10. Further, at this time, in a case where the current position of the comet acquired in the process of SP62 is set as the end point, the determination unit 64 stores the fact that the end point is included within the imaging range. On the basis of the information stored in the processing of SP44 and SP64, the determination unit 64 may determine whether or not the end point is included within the imaging range of the camera 34 after the start point is included within the imaging range of the camera 34. The processing then proceeds to processing of SP66.

### (SP66)

The image acquisition unit 54 of the server device 10 determines whether or not the current time has elapsed from the start point time to the end point time. When the determination is negative, the processing proceeds to the processing of SP46, and the process of accepting the posting of the user input image 106 is performed. When the determination is positive, the processing proceeds to processing of SP68.

### (SP68)

The image acquisition unit 54 refers to the user input image table 50C and extracts a plurality of or all of the “file paths of user input images” included between the start point time and the end point time. Subsequently, the image acquisition unit 54 acquires the user input images 106 stored in the storage locations indicated by the respective “file paths of user input images” that have been extracted. The processing then proceeds to processing of SP70.

### (SP70)

The output unit 60 of the server device 10 outputs, together with the plurality of user input images 106 acquired in the processing of SP68, the artwork 104 associated with these user input images 106. The output unit 60 outputs the plurality of user input images 106 by, for example, having them projected as projection mapping or the like on a ceiling or the like of an event venue at which content is shared. It is to be noted that the output unit 60 may output the plurality of user input images 106 in response to the determination, in the processing of SP64, that the end point is included within the imaging range of the camera 34 after the start point is included within the imaging range of the camera 34. The series of processing depicted in FIG. 13 ends as above.

### Operations and Effects

As described above, the server device 10 according to the present embodiment acquires information indicating the current position of the comet moving above the earth with elapse of time, causes the artwork 104 to be displayed on the user terminal 12 in a case where the current position of the comet is included within the imaging range to be captured by the user terminal 12, and accepts, from the user terminal 12, the posting of the user input image 106 as a commentary on the artwork 104 displayed.

According to this configuration, for example, in a case where the user holds the camera 34 of the user terminal 12 up to the sky at a timing when the comet moves to the user's current position, and the current position of the comet is included within the imaging range of the camera 34, then the artwork 104 is displayed and the user input image 106 with respect to the artwork 104 can be posted. Accordingly, it is possible to give a production effect as if the artwork 104 had traveled around the world and visited the user at a once-in-a-lifetime timing or a production effect as if a virtual event venue where content is shared among users were moving around the world. In other words, it is possible to provide users with an experience of “art transcends time and space” and a way of enjoying a new expression of “art visits you.” In this way, it is possible to provide users with a special experience through the content.

Further, the information processing system 1 according to the present embodiment includes the server device 10 and the user terminal 12, which can communicate with the server device 10. The server device 10 includes the storage unit 50, the display control unit 56, and the post acceptance unit 58. The storage unit 50 functions as the trajectory setting unit that sets the trajectory 100, which indicates a correspondence relation between the position and the time in the three-dimensional space. The display control unit 56 causes the artwork 104 corresponding to the trajectory 100 to be displayed on the user terminal 12 in a case where the user terminal 12 determines, at least on the basis of the position of the user terminal 12, that part of the trajectory 100 (the current position of the comet) is included within the imaging range to be captured by the user terminal 12. The post acceptance unit 58 accepts, from the user terminal 12, the posting of the user input image 106 with respect to the artwork 104 displayed by the display control unit 56. The user terminal 12 includes the position identification unit 62, the determination unit 64, and the input acceptance unit 68. The position identification unit 62 identifies the position of the user terminal 12. The determination unit 64 determines whether or not part of the trajectory is included within the imaging range to be captured by the user terminal 12, on the basis of the position identified by the position identification unit 62. The input acceptance unit 68 accepts the input of the user input image 106.

Further, an information processing method according to the present embodiment includes trajectory setting processing (SP10) of setting the trajectory 100, which indicates a correspondence relation between the position and the time in the three-dimensional space, display control processing (SP28) of causing the artwork 104, which corresponds to the trajectory 100, to be displayed on the user terminal 12 in a case where, at least on the basis of the position of the user terminal 12, part of the trajectory 100 is included within the imaging range to be captured by the user terminal 12, and post acceptance processing (SP34) of accepting, from the user terminal 12, the posting of the user input image 106 with respect to the artwork 104 displayed at the display control processing.

According to the information processing system 1, the server device 10, and the information processing method described above, an opportunity to view the artwork 104 and an opportunity to post the user input image 106 are limited at predetermined positions and predetermined times. Therefore, it is possible to give a production effect similar to the one described above and provide users with a special experience through content.

Further, in the present embodiment, the display control unit 56 causes the comet image 102 corresponding to the trajectory 100 to be displayed on the user terminal 12 in such a manner as to be superimposed on a video captured by the user terminal 12 in a case where part of the trajectory 100 (the current position of the comet) is included within the imaging range, and also causes the artwork 104 to be displayed in a case where a zoom-in operation with respect to the comet image 102 is accepted from the user terminal 12.

According to this configuration, the comet image 102 is displayed in such a manner as to be superimposed on the video captured by the user terminal 12, so that the user can be provided with a view through the user terminal 12 as if the user were viewing the comet actually moving in the sky through a telescope. Further, since the artwork 104 is displayed in response to the user's zoom-in operation with respect to the comet image 102, the user can be provided with an experience as if the artwork 104 had rode on the comet to visit the user. Further, since the comet image 102 that is appropriate as a view of the comet viewed from the current position of the user terminal 12 is displayed, it is possible to produce different views of the comet image 102 depending on the position of the user.

Further, in the present embodiment, when the post acceptance unit 58 accepts the posting of the user input image 106 from the user terminal 12, the post acceptance unit 58 also accepts the input of the signature information of the user of the user terminal 12 in association with the user input image 106.

According to this configuration, the input of the signature information is accepted in association with the posting of the user input image 106, so that the author of the user input image 106 can be proved by the signature information. In other words, this can produce an effect of “you can type commentary on art and prove that it is yours.”

Further, in the present embodiment, when the display control unit 56 causes the artwork 104 to be displayed, the display control unit 56 causes the user input images 106 that have been posted and accepted with respect to the artwork 104 to be displayed together with the artwork 104.

According to this configuration, the user input images 106 are displayed together with the artwork 104. Therefore, the user can have other users view the user input image 106 of the user and can view what the user input images 106 of other users are like. For example, it is possible to view the user input images 106 of other users and decide what kind of post to make.

Further, in the present embodiment, the storage unit 50 as the trajectory setting unit sets the start point and the end point of the trajectory 100, and the output unit 60, which outputs the user input images 106 that have been posted and accepted between the start point and the end point, together with the artwork 104 associated with the user input images 106, is further provided.

According to this configuration, since the posts of the user input images 106 are accepted at various positions and times between the start point and the end point of the trajectory 100, the number of posts of the user input images 106 with respect to the artwork 104 can be gradually increased and collected between the start point and the end point. Then, outputting the collected results can provide users with a special experience as if the artwork 104 had started from the start point, moved along the trajectory 100, and returned to the end point with more user input images 106 in tow in an event of sharing content among users.

### Modifications

The present disclosure is not limited to the embodiment described above. That is, design modifications made to the above-described embodiment by those skilled in the art as appropriate also fall within the scope of the present disclosure as long as the modifications have the features of the present disclosure. Further, the elements included in the embodiment described above and modifications to be described below can be combined as long as such combinations are technically possible, and such combinations also fall within the scope of the present disclosure as long as the combinations have the features of the present disclosure.

For example, the type of content is not limited to a still image and may be a moving image, a video (a moving image with sound), a text character, a pictogram, an illustration, or a combination of them. A virtual moving object is not limited to a comet and may be [1] a real flying object such as a plane, a drone, a rocket, a meteorite, a planet, or a bird or [2] a fictional flying object such as a dragon, an airship, or an unidentified flying object.

The functions of the determination unit 64 may be provided in the server device 10 instead of the user terminal 12. In this case, the user terminal 12 need only supply the position and posture information acquired by the user terminal 12 itself to the server device 10 on a regular or irregular basis. The trajectory 100 is not limited to one trajectory, and a plurality of trajectories may be set simultaneously.

In a case where the current position of the comet is included within the imaging range of the user terminal 12, the display control unit 56 may cause the artwork 104 to be displayed from the beginning without causing the comet image 102 to be displayed or may cause the artwork 104 to be displayed together with the comet image 102.

The copyright of the artwork 104 may be managed by a blockchain technology or the like. For example, the storage unit 50 may store authenticity information associated with the artwork 104. The authenticity information includes, for example, original author information, proof of sales information, authenticity appraisal information, authenticity management information, and secondary author information. The authenticity information may be a digital token including a non-fungible token (NFT). When the image acquisition unit 54 acquires the artwork 104, the image acquisition unit 54 may acquire the authenticity information corresponding to the artwork 104 from among pieces of information stored in the storage unit 50. When the display control unit 56 causes the artwork 104 to be displayed, the display control unit 56 may cause the authenticity information to be displayed on the user terminal 12.

Further, in the embodiment described above, an example of providing users with a special experience as an event in which content is shared among users has been described. However, the present disclosure is not limited thereto. For example, the present disclosure can also be applied to daily and general services and the like without limiting to events and can provide users with a special experience through content in such services.

The present disclosure may be the program 14 for causing a computer to function as each of the above-described functional configurations such as the storage unit 50, the display control unit 56, and the post acceptance unit 58. The program 14 may be stored in storage devices disposed inside the server device 10, the user terminal 12, or the like or stored in external storage devices connected to the server device 10, the user terminal 12, or the like through a network. Further, the program may be provided by being recorded on a computer-readable recording medium or provided through installation via a network such as the Internet. Here, the computer-readable recording medium may be, for example, configured as a storage device such as a hard disk drive (HDD) or a solid state drive (SSD) built into a computer system, or a portable medium such as an optical magnetic disk, a read only memory (ROM), a compact disc (CD)-ROM, or a flash memory.

### DESCRIPTION OF REFERENCE SYMBOLS

1: Information processing system
10: Server device (information processing device)
12: User terminal
50: Storage unit (trajectory setting unit)
56: Display control unit
58: Post acceptance unit
60: Output unit
62: Position identification unit
64: Determination unit
68: Input acceptance unit

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An information processing device comprising:
at least one processor; and
at least one memory storing at least one program that, when executed by the at least one processor, causes the information processing device to:
acquire information indicating a current position of a virtual moving object moving aboveground over time,
cause artwork to be displayed on a user terminal in a case where the current position of the virtual moving object is included within an imaging range to be captured by the user terminal, and
accept, from the user terminal, a posting of commentary on the artwork displayed on the user terminal.

2. An information processing device comprising:
at least one processor; and
at least one memory storing at least one program that, when executed by the at least one processor, causes the information processing device to:
set a trajectory indicating a correspondence relation between a position and a time in a three-dimensional space;
cause main content corresponding to the trajectory to be displayed on a user terminal in a case where, at least based on a position of the user terminal, part of the trajectory is included within an imaging range to be captured by the user terminal; and
accept from the user terminal, a posting of sub-content with respect to the main content displayed on the user terminal.

3. The information processing device according to claim 2, wherein the at least one program, when executed by the at least one processor, causes the information processing device to:
cause an image of a virtual moving object corresponding to the trajectory to be displayed on the user terminal such that the image of the virtual moving object is superimposed on video captured by the user terminal in a case where the part of the trajectory is included within the imaging range, and
cause the main content to be displayed in a case where a predetermined operation with respect to the image of the moving object is accepted from the user terminal.

4. The information processing device according to claim 2, wherein the at least one program, when executed by the at least one processor, causes the information processing device to:
when the posting of the sub-content is accepted from the user terminal, accept an input of signature information of a user of the user terminal in association with the sub-content.

5. The information processing device according to claim 2, wherein the at least one program, when executed by the at least one processor, causes the information processing device to:
when the main content is caused to be displayed on the user terminal, cause the sub-content that has been posted and accepted with respect to the main content to be displayed together with the main content.

6. The information processing device according to claim 2, wherein the at least one program, when executed by the at least one processor, causes the information processing device to:
set a start point and an end point of the trajectory, and
output the sub-content that has been posted and accepted between the start point and the end point, together with the main content associated with the sub-content.

7. A non-transitory computer-readable medium storing a program that, when executed by a computer, causes the computer to:
set a trajectory indicating a correspondence relation between a position and a time in a three-dimensional space;
cause main content corresponding to the trajectory to be displayed on a user terminal in a case where, at least based on a position of the user terminal, part of the trajectory is included within an imaging range to be captured by the user terminal; and
accept, from the user terminal, a posting of sub-content with respect to the main content displayed on the user terminal.
